(19) United States
(12) Patent Application Publication
(10) Pub. No.: US 2015/0251474 A1
(43) Pub. Date: Sep. 10, 2015

(54) SHEET PROCESSING APPARATUS, INFORMATION PROCESSING APPARATUS, METHOD OF CONTROLLING THE SAME, AND COMPUTER-READABLE STORAGE MEDIUM

(71) Applicant: CANON KABUSHIKI KAISHA, Tokyo (JP)

(72) Inventor: Hideaki Ooba, Yokohama-shi (JP)

(21) Appl. No.: 14/632,367

(22) Filed: Feb. 26, 2015

(30) Foreign Application Priority Data
Mar. 10, 2014 (JP) 2014-046758

(51) Int. Cl. B42C 5/00

(52) U.S. Cl. CPC B42C 5/00

(57) ABSTRACT

In an information processing apparatus operable to issue a job including bookbinding processing using a sheet, when a setting of a perforation for a sheet on which bookbinding processing is performed is instructed, a page for which the perforation is set and a position of the perforation are designated, and it is determined whether or not the designated position of the perforation is valid; and a result of the determination is presented to a user.

### BACKGROUND OF THE INVENTION

1. Field of the Invention

The present invention relates to a sheet processing apparatus, an information processing apparatus, a method of controlling the same, and a computer readable storage medium.

2. Description of the Related Art

Conventionally, various documents have been generated using post-processing apparatuses that process sheets on which images are formed by an image forming apparatus. An example of a post-processing apparatus is a bookbinding device which performs bookbinding processing on a plurality of sheets as a bundle. A saddle binding (saddle stitch binding) device, which creates a simple book by folding a sheet bundle at a central portion, and stapling a folded portion is an example of one of these. There are also case binding devices that bundle sheets of a body, and next apply a glue to the back portion of the sheet bundle of the body, and finally bind the sheets of the body by causing a front cover to adhere so as to envelop them. Also, unlike a bookbinding device which processes sheets as a bundle, there are post-processing devices that perform processing on sheets individually. For example, there are folding devices whose purpose is to fold a sheet into a shape into which it is easy to insert something, such as an envelope, by dividing the sheet into three surfaces, folding one surface inwardly, and folding so as to overlay the surface on the opposite side (C fold). Furthermore, there are perforation processing devices that add a tear-off line at a tear-off position (a perforation) in order that it be easy to tear off a portion when it is desired that the portion of a sheet be torn off and used.

A user is able to obtain a desired resulting document by connecting a post-processing apparatus capable of obtaining the desired resulting document to an image forming apparatus and then applying processing settings as appropriate. Thus, it is necessary to perform print processing considering the properties, settings, and the like, of bookbinding devices in order to obtain a desired resulting document, and systems are known already which are capable of realizing application of post-processing determined in advance to the resulting document.

For example, in the invention recited in Japanese Patent Laid-Open No. 02-158393, the object is to obtain a resulting document to be delivered to a target person such that other people cannot easily see confidential information for mail articles. More specifically, a printed material is folded into three, glued in the necessary locations, and perforation processing is performed around the glued locations. It is disclosed that with this, a sealed binding resulting document, which can be opened to a continuous information surface by tearing the perforated portion, can be provided.

However, because in the above described prior art, performing at a necessary location post-processing necessary to obtain a specific resulting document is being considered, it is not considered what perforation position is appropriate considering the characteristics of post-processing devices in other post-processing (case binding, saddle binding), or the like. There is a problem in that, if perforation processing is performed at a location at which stapling of a folded portion is performed in saddle binding, both sides of a page will be simultaneously torn off when tearing off at the perforation. Also, when performing a case binding print, the effect of a perforation will not be achieved when the perforation is performed on a portion to which glue is applied. Furthermore, when performing a case binding in which there is a large number of pages, when the perforation processing is performed on a page in the middle of the printed materials, there is the possibility that it is undesirable to perform perforation processing beside a glued portion to avoid the glued portion. This is because when perforation processing is performed in the middle of a case binding and the perforation is designated to be beside a glued portion, the other pages interfere when the user actually tries to tear off the page, and so the tearing off of the page becomes difficult. In this way, there is a problem in that it is necessary for the user to set the position of the perforation considering the details of post-processing other than the perforation, and when these are not considered, the effect of the perforation cannot be obtained.

### SUMMARY OF THE INVENTION

The present invention provides a technique in which a user can set a perforation easily for a sheet on which bookbinding is performed.

A sheet processing apparatus operable to add a perforation to a sheet on which bookbinding processing is performed comprises a first determination unit configured to determine whether or not a perforation is set for a sheet on which bookbinding processing is performed; a second determination unit configured to, when it is determined by the first determination unit that the perforation is set, determine whether or not a position of the set perforation is valid; and a presentation unit configured to present a result determined by the second determination unit to a user.

By virtue of the present invention, when performing perforation processing on a sheet, when a user designates a position of a perforation, it can be determined whether or not that position is a valid position, and the result of the determination can be presented to the user.

Further features of the present invention will become apparent from the following description of exemplary embodiments (with reference to the attached drawings).

Note, in the accompanying drawings, the same reference numerals are added for same or similar configuration elements.

### BRIEF DESCRIPTION OF THE DRAWINGS

FIG. 1 is a view for explaining characteristics of bookbinding processing.

FIG. 2A and FIG. 2B are views for showing an image forming apparatus (MFP) connection configuration.

FIG. 3 is a view for explaining a printing system on the whole.

FIG. 4 is a block diagram for showing a hardware configuration for a main controller.

FIG. 5 is a top view of an operation unit.

FIG. 6A is a block diagram for explaining an overview of a hardware configuration of a PC.

FIG. 6B is a flowchart for describing processing by a printer driver of the PC according to a first embodiment.

FIG. 7 is a view for showing an example of a screen of a case in which a print method is designated to be “single-sided printing” on a finishing setting screen.

FIG. 8A is a view for illustrating an example of a warning screen displayed when a perforation is set to be near a position of a staple.

FIG. 8B is a view for showing an example of a screen for notifying that the setting of a perforation is invalid.

FIG. 9 is a view for showing an example of a screen in a case in which a print method is designated to be “bookbinding print” on a finishing setting screen.

FIG. 10 is a view for showing an example of a screen in a case in which a print method is designated to be “case binding (double-sided)” on a finishing setting screen.

FIG. 11 is a flowchart for describing perforation setting processing by a printer driver of the PC.

FIG. 12 is a view for illustrating an example of a bookbinding details screen.

FIG. 13 is a view for illustrating an example of a perforation setting screen for setting a perforation.

FIG. 14 is a view for showing an example of a screen in which a preview screen showing a position at which a perforation is set is displayed on the left side of the perforation setting screen of FIG. 13.

FIG. 15A is a view for showing an example in which it is set how far from the center of the sheet the position needs to be for performing a perforation to be effective for A4 and A3 sizes, and thin paper and thick paper sheets.

FIG. 15B is a view for showing an example of a screen for warning a user.

FIG. 15C is a view for showing an example of a confirmation screen.

FIG. 16 is a view for illustrating an example of a case binding finishing setting screen.

FIG. 17 is a view for showing an example of a screen in which a preview screen showing a position at which a perforation is set is displayed on the left side of the perforation setting screen.

FIG. 18 is a view in which a resulting document to which case binding is performed is seen from above.

FIG. 19 is a flowchart in which the image forming apparatus processes a job in which a perforation is designated.

### DESCRIPTION OF THE EMBODIMENTS

Embodiments of the present invention will be described hereinafter in detail, with reference to the accompanying drawings. Note that it is to be understood that the following embodiments are not intended to limit the scope of the claims of the present invention, and that not all of the combinations of the aspects that are described in the present embodiment are necessarily required with respect to the means to solve the problems according to the present invention. Note that in the embodiments explained below, explanation will be given for cases in which a PC, or an image forming apparatus (MFP), which are concrete examples of a sheet processing apparatus of the present invention, set a perforation for a sheet on which bookbinding is performed.

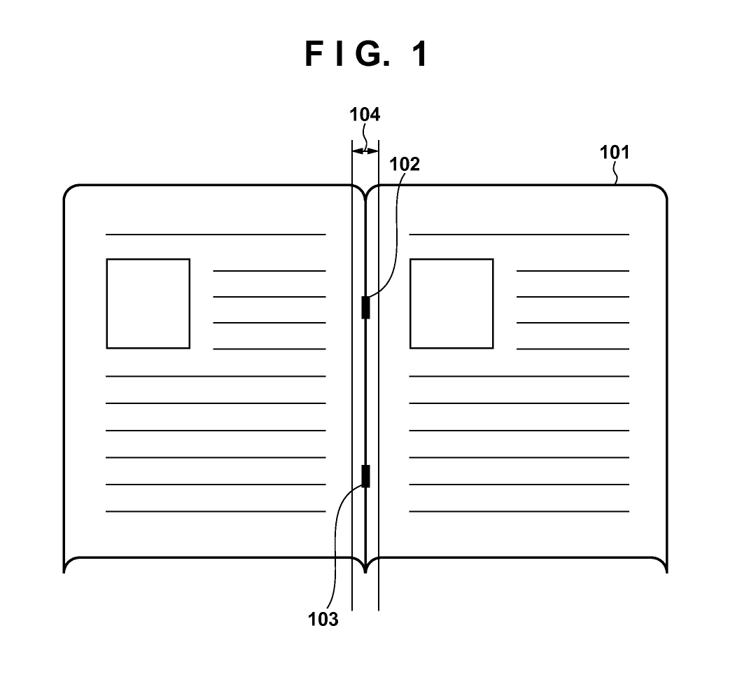

FIG. 1 is a view for explaining characteristics of the embodiment.

Reference numeral 101 denotes a double-page spread of a book bound by saddle stitch binding (saddle binding). Reference numerals 102 and 103 denote staple locations. An area 104 denotes a range in which a perforation effect cannot be achieved sufficiently when the perforation is designated in the range when stapling is designated in the saddle binding. In the present embodiment, the user is notified that the perforation designation is not optimal when it is detected that the user designated the perforation within this range.

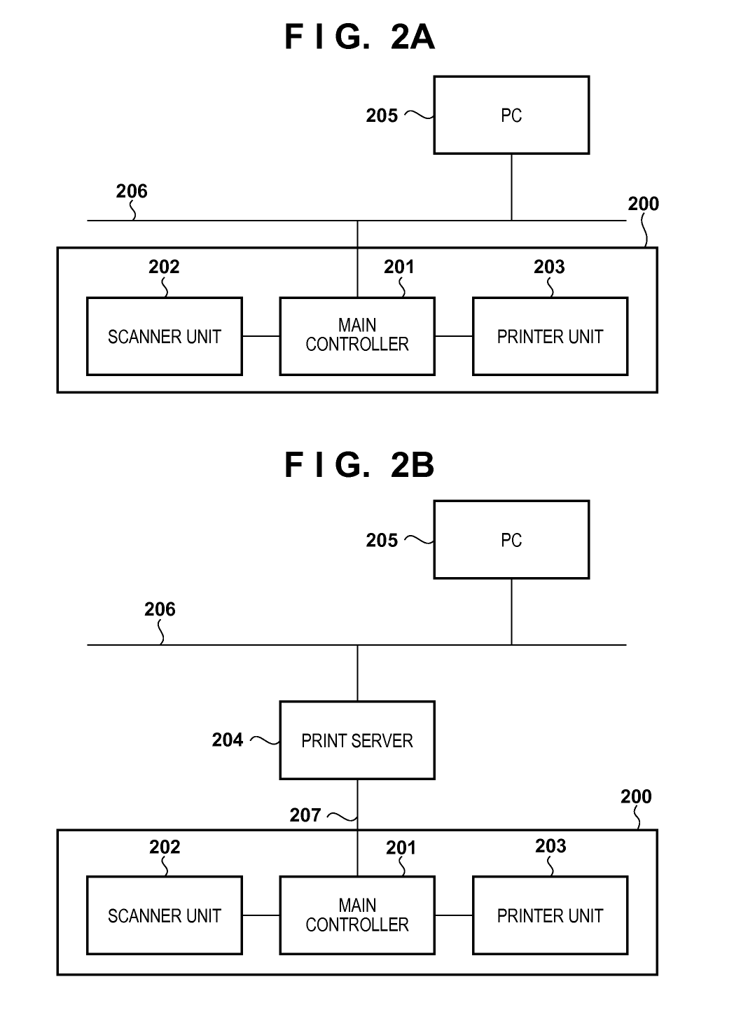

FIG. 2 is a view that shows an image forming apparatus (MFP) 200 connection configuration according to the embodiment.

In FIG. 2A, the MFP 200 is connected to a network 206 directly. In FIG. 2B the MFP 200 is connected to the network 206 via a print server 204.

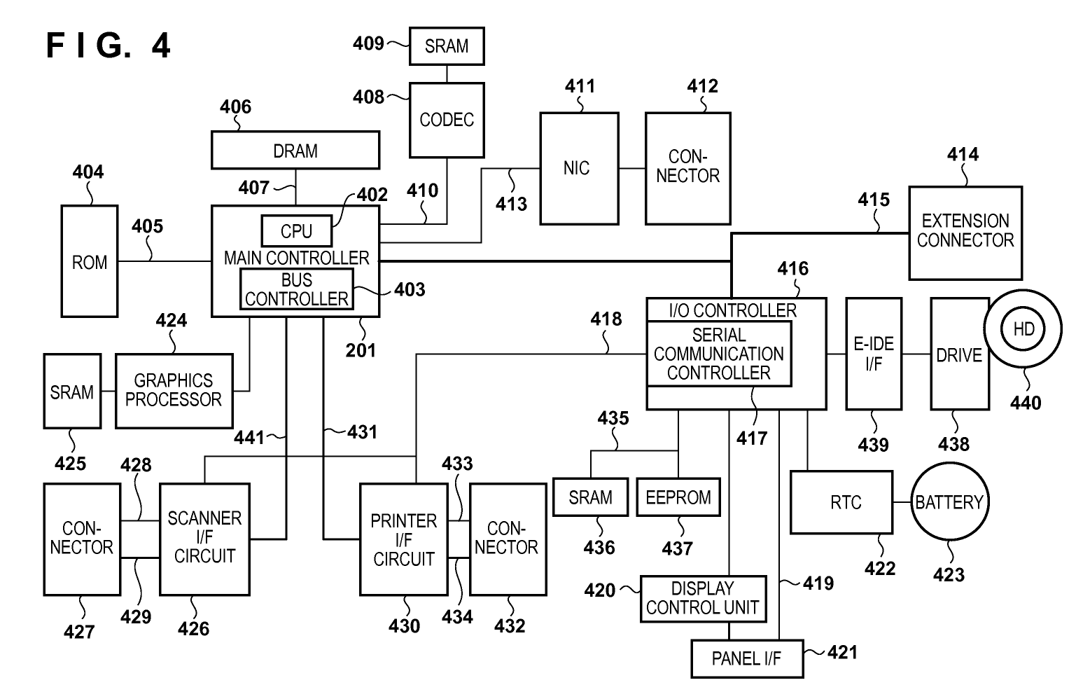

A main controller 201 mainly performs job scheduling control. A scanner unit 202 reads an original document, and generates image data for the original document. A printer unit 203 prints an image in accordance with the image data. Details of the main controller 201, the scanner unit 202, and the printer unit 203 will be explained later with reference to FIG. 4.

Also, the main controller 201 is connected to a PC (an information processing apparatus) 205 via the network 206. The PC 205 inputs jobs into the main controller 201 using a printer driver, or the like.

In FIG. 2B, the print server 204 first receives a print job inputted from the PC 205, which is connected to the network 206, and performs image processing. When this processing finishes, the job is input into the main controller 201 via a local network 207. Here, if image processing finishes without an instruction from a user, the main controller 201 inputs the job as is. Alternatively, configuration may be taken such that the job is first stored in the print server 204 when the image processing finishes, and then input into the main controller 201 at a time at which the user desires to print it. Configuration is such that the MFP 200 and the print server 204 are seen collectively as a single printing system from the external network 206.

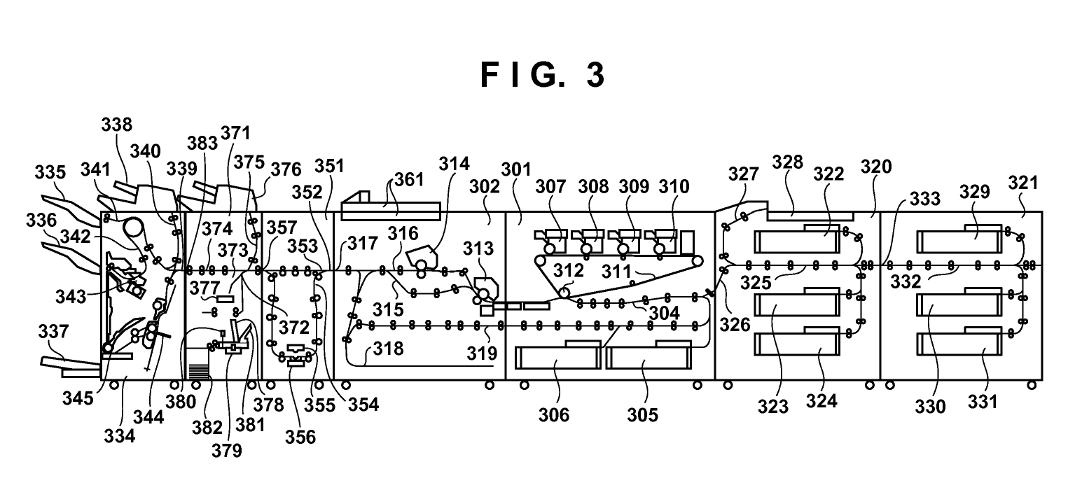

FIG. 3 is a view for explaining the printing system on the whole according to the embodiment.

The system includes an image forming apparatus main body 301 and an image fixing apparatus 302, and by these, image forming onto a sheet is performed. Note that a relationship with the previously described FIG. 2 is that the printer unit 203 includes the image forming apparatus main body 301 and the image fixing apparatus 302, and the main controller 201 is arranged in the image forming apparatus main body 301. Also, the scanner unit 202 corresponds to a later explained scanner 361.

A large-volume sheet feeding deck 320 is connected on the right side of the image forming apparatus main body 301 as a sheet feeding apparatus, and a plurality of such sheet feeding decks can be connected; furthermore, a large-volume sheet feeding deck 321 is connected on the right side of the large-volume sheet feeding deck 320. Also a creaser 351 is connected on the left side of the image fixing apparatus 302 as a post-processing apparatus. The creaser 351 is a post-processing device that applies a fold in advance to a location at which a sheet is to be folded, and control of the post-processing apparatus that is characteristic of this embodiment is related to control of the creaser 351. Also, a finisher 334 is connected on the left side of the creaser 351.

The image forming apparatus main body 301 has sheet feeding decks 305 and 306, and these operate as standard sheet feeding units. Developing units 307-310 are configured in four colors of developing units for Y (yellow), M (magenta), C (cyan) and K (black) from left to right for forming a color image. A toner image formed by these developer units is primary transferred to an intermediate transfer belt 311 that rotates in a clockwise direction in the figure, and at a secondary transfer position 312 the image is transferred to the sheet which is conveyed over a sheet conveyance path 304. The sheet to which the image is transferred in this way is sent from the image forming apparatus main body 301 to the image fixing apparatus 302, and a transfer image is fixed to the sheet by it being heated and pressurized at a fixing device 313. Then, the sheet, having passed through the fixing device 313, passes along a conveyance path 315, and is conveyed to a discharge orifice 317. When, based on the type of the sheet further heating and pressurization is required for fixing, the sheet, having passed through the fixing device 313, is conveyed to a second fixing device 314 via an upper conveyance path, and after heating and pressurization are applied, the sheet is conveyed to the discharge orifice 317 passing along a conveyance path 316. Also, when it is a double-sided image forming mode, the sheet, to which the image is fixed on a first surface, is conveyed along a double-sided feeding path 319 and re-fed after being inverted by being conveyed to a sheet reversing path 318, and image forming is once again performed on the second surface at the secondary transfer position 312.

It is possible to feed sheets from the three stages of sheet feeding decks 322-324 of the large-volume sheet feeding deck 320 outside of the standard sheet feeding units 305 and 306 of the image forming apparatus. A sheet fed from the large-volume sheet feeding deck 320 is conveyed along sheet conveyance paths 325 and 326, and sent to the image forming apparatus main body 301, in which image formation is performed. When the large-volume sheet feeding deck 321 is connected as in the figure, a sheet can be fed from sheet feeding decks 329-331, and a sheet, having been conveyed over a sheet conveyance path 322, is passed to the first large-volume sheet feeding deck 320 at a discharge orifice 333. The large-volume sheet feeding decks 320 and 321 have a function of detecting an overlapping feed wherein a plurality of sheets are conveyed in a state in which they are overlapping, and when an overlapping feed is detected, the sheet conveyance path is switched from the normal conveyance path 326 to a conveyance path 327, and the sheets are discharged to an escape tray 328.

Next, explanation will be given for the creaser (perforation processing device) 351 which is a post-processing apparatus. The perforation processing device 351 is a post-processing apparatus that adds a perforation at a predetermined position on the sheet. A sheet for which image formation by the image fixing apparatus 302 has completed is input into a sheet conveyance unit of the perforation processing device 351 via the discharge orifice 317. Here, when there is a designation of perforation processing, the sheet passes along a sheet conveyance path 354 from a sheet conveyance path 352 and is perforated by being pinched between a perforation blade 355 and a blade rest 356. The perforation blade 355 can be changed in accordance with a grammage and type of the sheet, and a user can set an optimal perforation blade when that is done. When the perforation processing is finished, the sheet passes through a discharge orifice 357 and is conveyed out to the next post-processing device. When there is no designation for the perforation processing, the sheet passes along a sheet conveyance path 353 from the sheet conveyance path 352 and is discharged through the discharge orifice 357.

Next, explanation will be given for a case binding device 371 which is a post-processing apparatus. Note that explanation is given having the main controller 201 of FIG. 2 control the operation of the case binding device 371.

The case binding device 371 selectively conveys a sheet that was conveyed from an upstream apparatus on three conveyance paths. One of these is a front cover path 372, one is a main body path 373, and one is a straight path 374. Also, the case binding device 371 has an inserter path 375. The inserter path 375 is a sheet conveyance path for conveying a sheet that is placed on an inserter 376 to the front cover path 372. The straight path 374 is a sheet conveyance path for conveying a sheet for a job for which case binding processing by the case binding device 371 is not required to a subsequent apparatus. The main body path 373 and the front cover path 372 are sheet conveyance paths for conveying a sheet for which it is necessary to generate a case binding print material. For example, when a case binding print material is generated using the case binding device 371, the main controller 201 causes image data, for a body that is printed, to be printed on sheets for the case binding print material body by the printer unit 203. When a case binding print material is generated for one book, a sheet bundle for one book of sheets for this body is covered by one front cover. In the case binding, the sheet bundle for this body is referred to as “a main body”. The main controller 201 controls so as to convey the sheets that are printed by the printer unit 203 and that will become the main body, to the main body path 373. Then, the main controller 201 executes processing to envelop the main body which has been printed in the printer unit 203 by a sheet for the front cover which is conveyed via the front cover path 372 when the case binding processing is performed. The main controller 201 causes the sheets that become the main body, which are conveyed from the upstream apparatuses, to be stacked sequentially on a stacking unit via the main body path 373. The sheets to which body data has been printed are stacked by a stacking unit to a number of sheets that corresponds to the book, and the main controller 201 causes one sheet for the front cover which is required for the job to be conveyed via the front cover path 372. The main controller 201 controls a gluing unit 377 so as to perform gluing processing on a spine cover portion of the sheet bundle for the set corresponding to the main body. After that, the main controller 201 controls so as to cause the spine cover portion of the main body and the central portion of the front cover to be bonded by a gluing unit. When the main body is bonded to the front cover, the main body is conveyed so as to be pushed to a lower side of the apparatus. With this, folding processing is performed on the front cover so that the main body is covered by the front cover. After this, the sheet bundle for this set is stacked on a turn table 379 against a guide 378. After the sheet bundle for the set is set in the turn table 379, the main controller 201 causes sheet trimming processing to be executed on the sheet bundle by a cutter unit 380. Here, it is possible to execute three-side trimming processing for trimming the three ends other than the end corresponding to the spine cover portion in the sheet bundle of the set by the cutter unit 380. After this, the main controller 201 causes the sheet bundle, on which the three-side trimming processing has been performed, to be contained in a basket 382 by pushing the sheet bundle in the direction of the basket 382 using a side pushing unit 381.

Furthermore, when the sheet is conveyed to a post-processing apparatus downstream of the case binding device 371, the sheet is conveyed via a sheet conveyance path 383 and conveyance path 339, and conveyed to the finisher 334. Next, explanation will be given for the finisher 334. The finisher 334 applies post-processing to sheets already printed in accordance with a function that the user designated. More specifically, it has functions for stapling (binding at 1 location/2 locations), punching (2 holes/3 holes), saddle stitch bookbinding, or the like. In the finisher 334 there are sheet discharge trays 335 and 336, and a sheet is discharged via a sheet conveyance path 341 to a sheet discharge tray 335. Is not possible to perform processing such as stapling on the sheet conveyance path 341. When processing such as stapling is performed, a sheet passes along a sheet conveyance path 342, and after the post-processing that was designated by the user is performed by a processing unit 343, the sheet is discharged to the sheet discharge tray 336. The sheet discharge trays 335 and 336 are capable of moving up and down, and it is possible to operate so as to stack sheets on which post-processing was performed by the processing unit 343 from the bottom discharge orifice by lowering the sheet discharge tray 335. When an inserted sheet is designated by a designation of a user, it is possible to cause operation such that the inserted sheet, which is set in an inserter 338 for a predetermined page, is caused to pass along a sheet conveyance path 340 and to be inserted. When saddle stitch bookbinding is designated, sheets, after having been stapled in the center of the sheets by a saddle stitching processing unit 344, are folded in two, pass along a sheet conveyance path 345, and are outputted to a saddle stitch bookbinding tray 337. The tray 337 is of a conveyor-belt configuration, and the configuration is such that a saddle stitch bookbinding bundle stacked on the tray 337 is conveyed to a left side.

Next, simple explanation will be given for the scanner 361 and a document feeder.

These are mainly used for a copy function, and when an original document is set on an original document platen and read, the original document is set on the original document platen and the document feeder is closed. Then, an open/close sensor detects that the original document platen is closed, and a reflective-type original document size detection sensor comprised in the housing of the scanner 361 detects the size of the original document that is set. Upon the detection of the size, the original document is irradiated by a light source, an image is read by a CCD and converted to a digital signal, and by performing desired image processing, the image is converted into a laser recording signal. The converted recording signal is stored in a main controller memory which is explained in FIG. 4, which will be explained later.

When an original document is set in the document feeder and read in, the original document is placed face-up in an original document setting unit of the document feeder. With this, the sensor for detecting the existence or absence of an original detects that the original document is set, an original document feed roller and a conveyer belt rotate having received notification of the detection, and by conveying the original document, the original document is set at a predetermined position on the original document platen. After this, similarly to the reading on the original document platen the image is read, and stored in a memory of the main controller 201.

FIG. 4 is a block diagram for showing a hardware configuration of the main controller according to embodiments.

The main controller 201 mainly comprises a CPU 402, a bus controller 403, and various I/F controller circuits. The CPU 402 and the bus controller 403 control operation of the device on the whole, and the CPU 402 reads out programs from a ROM 404 via a ROM I/F 405, and operates in accordance with those programs. Also, operation for interpreting PDL (page description language) code data received from the PC 205, and expanding this into raster image data is described in such programs, and is processed by software. The bus controller 403 controls data transfer of data inputted/outputted by various I/Fs, and performs control of bus arbitration, DMA data transfer, or the like.

A DRAM 406 is connected to the main controller 201 by a DRAM I/F 407, and the DRAM 406 is used for programs that the CPU 402 executes, as a work area for operation, and as an area for storing image data. A codec 408 compresses raster image data stored in the DRAM 406 in format such as MH/MR/MMR/JBIG/JPEG or the like, and conversely decompresses the code data that is compressed and stored into raster image data. An SRAM 409 is used as a temporary work area of the codec 408. The codec 408 is connected to the main controller 201 via an I/F 410, and transferring of data between the codec 408 and the DRAM 406 is performed by DMA and is controlled by the bus controller 403. A graphics processor 424 performs processing such as rotation, magnification/reduction, color space conversion, binarization, or the like, on the raster image data stored in the DRAM 406. An SRAM 425 is used as a temporary work area of the graphics processor 424. The graphics processor 424 is connected to the main controller 201 through an I/F, and transferring of data between the graphics processor 424 and the DRAM 406 is performed by DMA and is controlled by the bus controller 403.

A network controller (NIC) 411 is connected to the main controller 201 by an I/F 413, and is connected to an external network by a connector 412. The network is commonly Ethernet (registered trademark). To a general high-speed bus 415 an extension connector 414 for connecting an extension board and an I/O controller 416 are connected. The general high-speed bus is commonly a PCI bus. An asynchronous serial communication controller 417 for transmitting and receiving CPU control commands of the scanner unit 202 and the printer unit 203 is comprised in the I/O controller 416 with two channels. A scanner I/F circuit 426 and a printer I/F circuit 430 are respectively connected by an I/O bus 418.

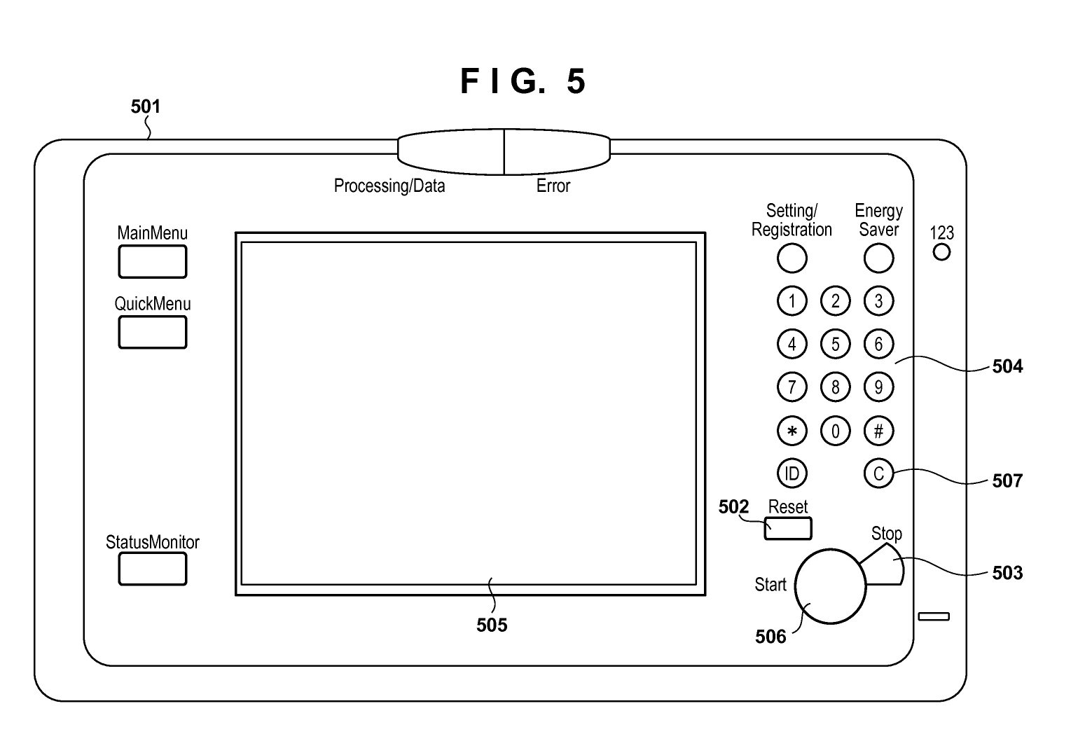

A panel I/F 421 is connected to a display control unit 420 and is connected to the I/O controller 416 via a bus 419, and comprises an I/F for performing a display to a screen of a display unit of an operation unit 501 (FIG. 5), and a key input I/F for performing hard key or touch panel key input. The operation unit 501 has a display unit, a touch panel input apparatus affixed to the display unit, and a plurality of hard keys. A signal input by the touch panel or the hard keys is conveyed to the CPU 402 via the panel I/F 421, and the display unit displays image data sent from the panel I/F 421. Note that print system function display, image data, or the like, are displayed on the display unit.

A real-time clock module (RTC) 422 is for updating/saving the date and time managed within the apparatus, and the real-time clock module (RTC) 422 is backed up by a backup battery 423. An E-IDE interface 439 connects an external storage apparatus. In the present embodiment, a hard disk drive 438 is connected via the I/F 439, image data is stored to a hard disk 440, and the image data is read from the hard disk 440. Connectors 427 and 432 are respectively connected to the scanner unit 202 and the printer unit 203, and are connected to asynchronous serial I/Fs (428, 433) and video I/Fs (429, 434). A scanner I/F 426 is connected to the scanner unit 202 via a connector 427, and is connected to the main controller 201 by a scanner bus 441, and the scanner I/F 426 applies predetermined processing to image data received from the scanner unit 202. Furthermore, it has a function for outputting a control signal generated based on a video control signal sent from the scanner unit 202 to a scanner bus 429. Data transfer from the scanner bus 429 to the DRAM 406 is controlled by the bus controller 403.

A printer I/F 430 is connected to the printer unit 203 via a connector 432, and is connected to the main controller 201 by a printer bus 431. Then predetermined processing is applied to image data output from the main controller 201, and the result is output to the printer unit 203. Furthermore, it has a function for outputting a control signal generated based on a video control signal sent from the printer unit 203 to the printer bus 431. When raster image data loaded into the DRAM 406 is transferred to the printer unit 203 the bus controller 403 controls the transferring, and image data is transferred by DMA via the printer bus 431 and the video I/F 434 to the printer unit 203. An SRAM 436 is able to hold storage contents by a power source supplied from a backup battery even if a power shutdown is performed for the apparatus on the whole, and the SRAM 436 is connected to the I/O controller 416 via a bus 435. An EEPROM 437 similarly is a memory that is connected to the I/O controller 416 via the bus 435.

Next, explanation will be given for the operation unit 501 by which various settings are performed.

FIG. 5 is a top view of the operation unit 501 according to embodiments.

A reset key 502 is used to cancel setting values that the user has set. A stop key 503 is a key for making an instruction to stop a job that is in operation. A numeric keypad 504 is keys for performing numeric value input of positioned numbers, or the like. A display unit 505 is equipped with a touch panel function, and is used to display various screens. A start key 506 is a key for causing a job for reading an original document, or the like, to be initiated. A clear key 507 is used to clear settings, or the like. Also an initial setting/registration button, a button for performing energy saving, a button for displaying a main menu, a quick menu button by which it is possible to configure a customized screen for each user, a status monitor button for displaying a status of the device, or the like, are arranged as hard keys.

Next, detailed explanation will be given for perforation designation processing which is characteristic of the present embodiment.

### First Embodiment

In the first embodiment, when a job that designates a perforation is transmitted by a printer driver of the PC 205, it is determined whether the perforation set by the user is at an appropriate position in a user interface of the printer driver. In the first embodiment, explanation is given having the PC 205 of FIG. 2 be the client that transmits the print job. However, the image forming apparatus may receive the job via an external interface such as the connectors 412, 414, 429, and 432, USB, or the like.

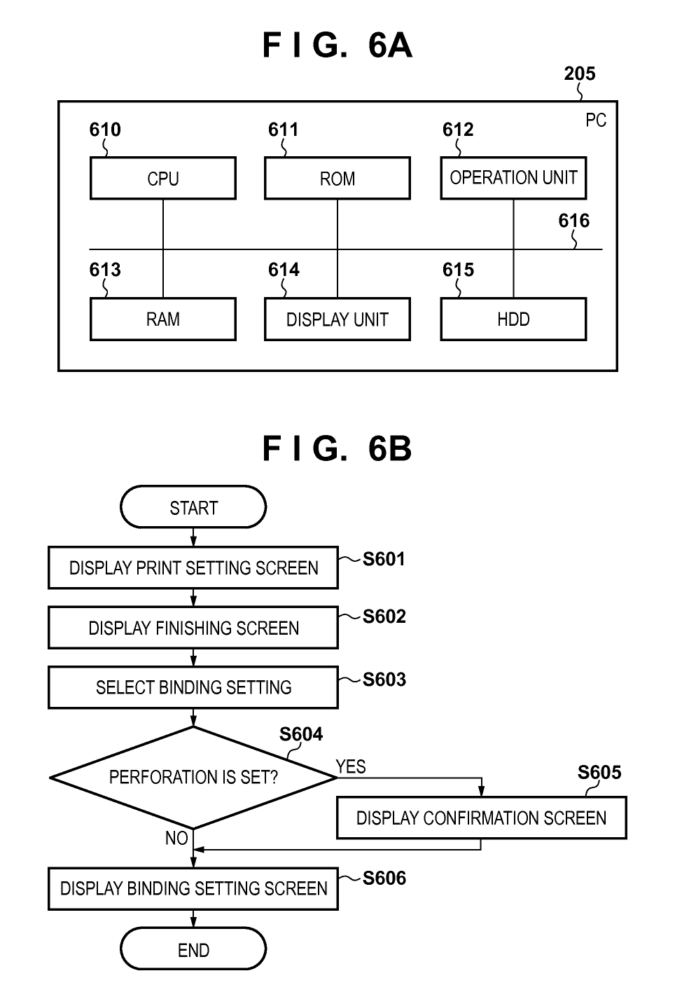

FIG. 6A is a block diagram for explaining an overview of a hardware configuration of the PC 205 according to the first embodiment.

A CPU 610 executes a boot program stored in a ROM 611, loads an OS and programs installed in an HDD 615 into a RAM 613, and executes the programs, thereby controlling the operation of the PC 205 on the whole. The ROM 611 stores the previously described boot program, setting information of the device, or the like. An operation unit 612 includes a keyboard, a pointing device, or the like, and the operation unit 612 receives operations by a user. The RAM 613 provides a program loading area and a work memory for the CPU 610. A display unit 614 is used to display messages, Web browser screens, input/output images, or the like, to the user. Note that the display unit 614 may have a touch panel function. The HDD (hard disk drive) 615 is a bulk storage unit which stores programs, an OS, a later explained printer driver, or the like. Note that in place of the HDD 615 a memory card such as an SDRAM, or the like, may be used. A system bus 616 connects these to the CPU 610. Note that FIG. 6A is shown omitting interface units arranged between each of the operation unit 612, the display unit 614, and the HDD 615 and the bus 616.

FIG. 6B is a flowchart for describing processing by a printer driver of the PC 205 according to the first embodiment. This processing is realized by the CPU 610 executing a program loaded into the RAM 613 of the PC 205.

Firstly, in step S601, the CPU 610 displays a print setting screen to the display unit 614. Next, the processing proceeds to step S602, and the CPU 610 displays a finishing setting screen to the display unit 614 in accordance with an instruction by the user.

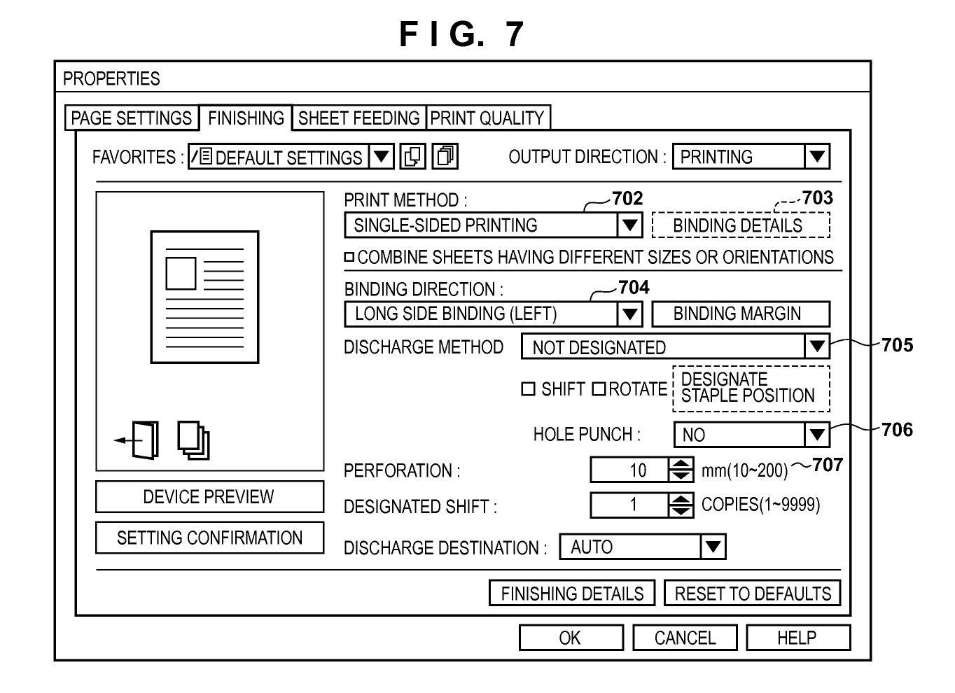

FIG. 7 is a view for showing an example of a screen in a case in which a print method 702 is designated to be “single-sided printing” on a finishing setting screen.

The print method 702 instructs the method for printing a sheet using this finishing processing. Here, either single-sided printing or double-sided printing can be selected, and here single-sided printing is set. A bookbinding details button 703 can be pressed when saddle binding print or case binding print is selected in the print method 702, and when the bookbinding details button 703 is pressed, a setting screen for performing a settings necessary in bookbinding prints is newly opened. In FIG. 7, the state is such that the bookbinding details button 703 is displayed in grey and cannot be pressed because it is single-sided printing.

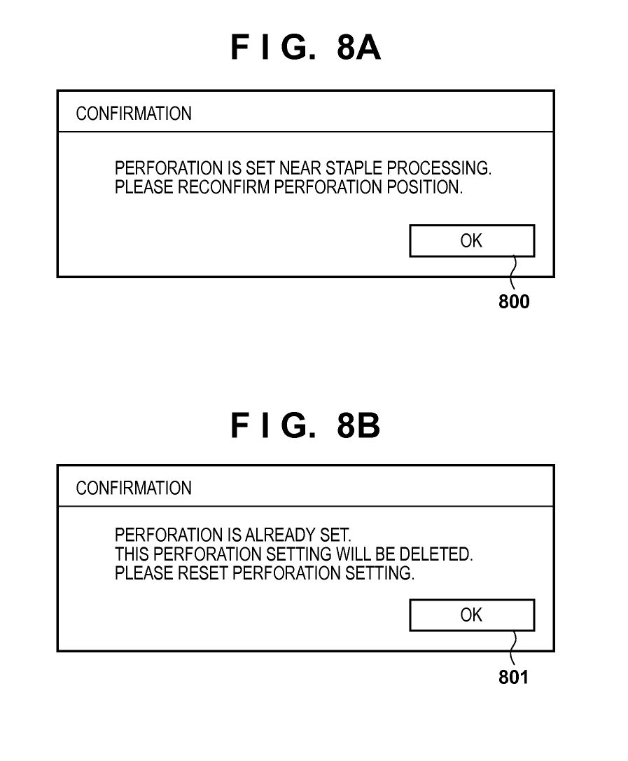

A binding direction 704 sets at what position to execute post-processing for stapling, punching, or the like, of the sheet. In the figure, it is set to “long-side binding (left)” for binding in parallel with the longer side. For a discharge method 705, a shift discharge, a sort discharge, or the like, can be selected. A hole punch 706 designates whether or not to perform punch processing. By a perforation 707 a position of a perforation can be designated. Here 10 mm from the longer side on the left side is set. Here, if stapling or punching is designated by the discharge method 705 or the hole punch 706, the position at which the staples or punching is applied is calculated, and if a perforation is designated at that position, a warning screen as shown in FIG. 8A is displayed.

When the user intentionally designates the perforation at the position of the punching or the staples, the user may press an OK button 800 on the warning screen. Note that configuration may also be taken such that the designation of a position for a perforation is not accepted in a region in which stapling or punching is performed.

Next, the flowchart of FIG. 6B is returned to once again, and after the finishing setting screen is displayed in step S602, the processing proceeds to step S603, and when the user selects bookbinding printing as the print method 702 on the screen of FIG. 7, the bookbinding details button 703 becomes pressable. Then, when the bookbinding details button 703 is pressed, the processing proceeds to step S604, and the CPU 610 determines whether or not a perforation is set. Here, if a value of a perforation setting 707 is anything other than “0”, it is determined that a perforation is set. When the perforation is not set, the processing proceeds to step S606, and the CPU 610 displays a detailed setting screen for bookbinding.

Meanwhile, when it is determined that a perforation setting has been made in step S604, the processing proceeds to step S605, and a screen that notifies the user that the setting of the perforation that was previously made has become invalid is displayed as shown in FIG. 8B, for example. Note that as other embodiments, configuration may be taken such that the setting of the perforation is once again caused to be executed, or a state is entered in which the perforation that was set is automatically input into the bookbinding details screen as is. Then, when it is detected that an OK button 801 is pressed on the screen of FIG. 8B, the processing proceeds to step S606.

FIG. 8B is a view for illustrating an example of a confirmation screen displayed in step S605 when the perforation setting is made. When in FIG. 8B bookbinding printing is instructed as the method for printing, the user is notified that the setting of the perforation that was previously made has been cancelled.

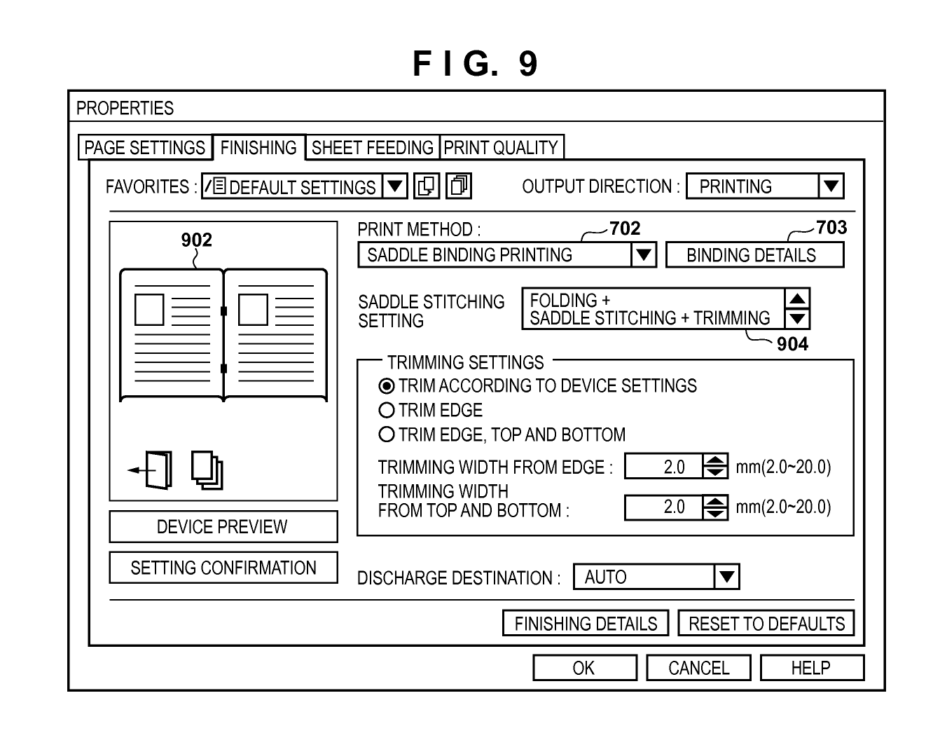

Also, when the user selects saddle binding as the print method 702 in step S602, a setting screen for saddle binding is displayed as shown in FIG. 9, for example.

FIG. 9 is a view for showing an example of a screen of a case in which the print method 702 is designated to be “saddle binding print” on the finishing setting screen.

In FIG. 9, the bookbinding details button 703 which was previously described becomes pressable, and a field 904 by which saddle stitching can be set is displayed. Here, folding, saddle stitching, and trimming are set. Also, reference numeral 902 denotes a pattern diagram for the resulting document when bookbinding is performed.

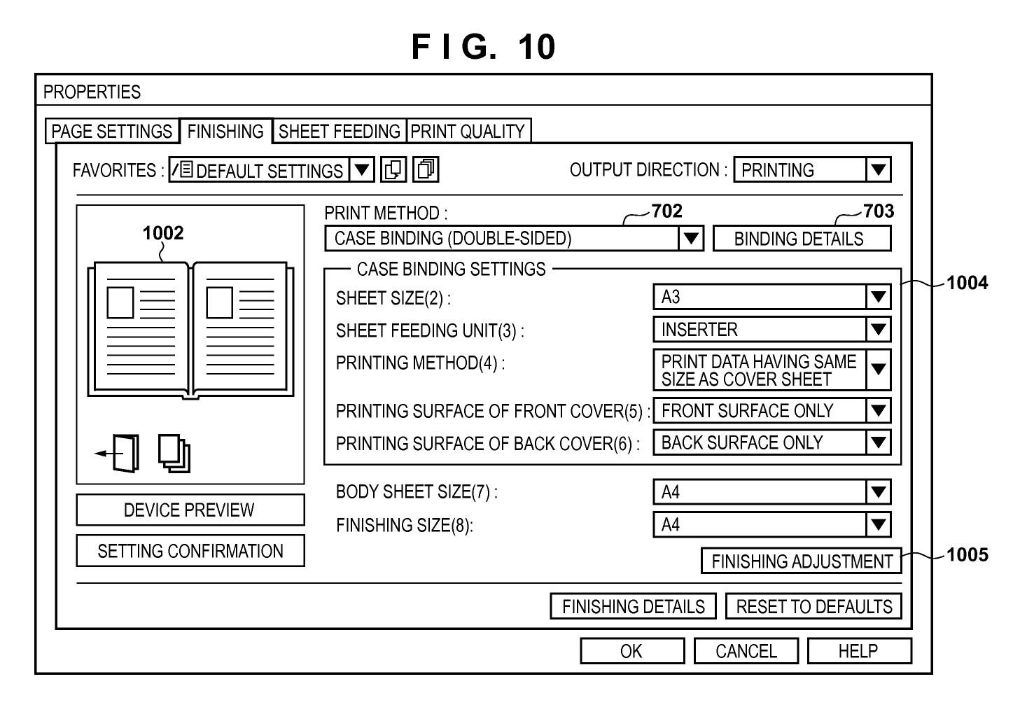

Also, when the user selects case binding as the print method 702 in step S602, a setting screen for case binding is displayed as shown in FIG. 10, for example.

FIG. 10 is a view for showing an example of a screen of a case in which the print method 702 is designated to be “case binding (double-sided)” on a finishing setting screen.

Here, the bookbinding details button 703 which was previously described becomes pressable, and a field 1004 by which a casing front cover can be set is displayed. Here, the sheet size of the front cover, its sheet feeding unit, the printing surface for the front cover, and the printing surface of the back cover can be set. Also, reference numeral 1002 denotes a pattern diagram for the resulting document when case binding is performed. Also, reference numeral 1005 is a button for instructing a finishing adjustment.

Next, explanation will be given for an embodiment for when a user selects saddle binding as the print method 702 on a finishing setting screen as shown in FIG. 9.

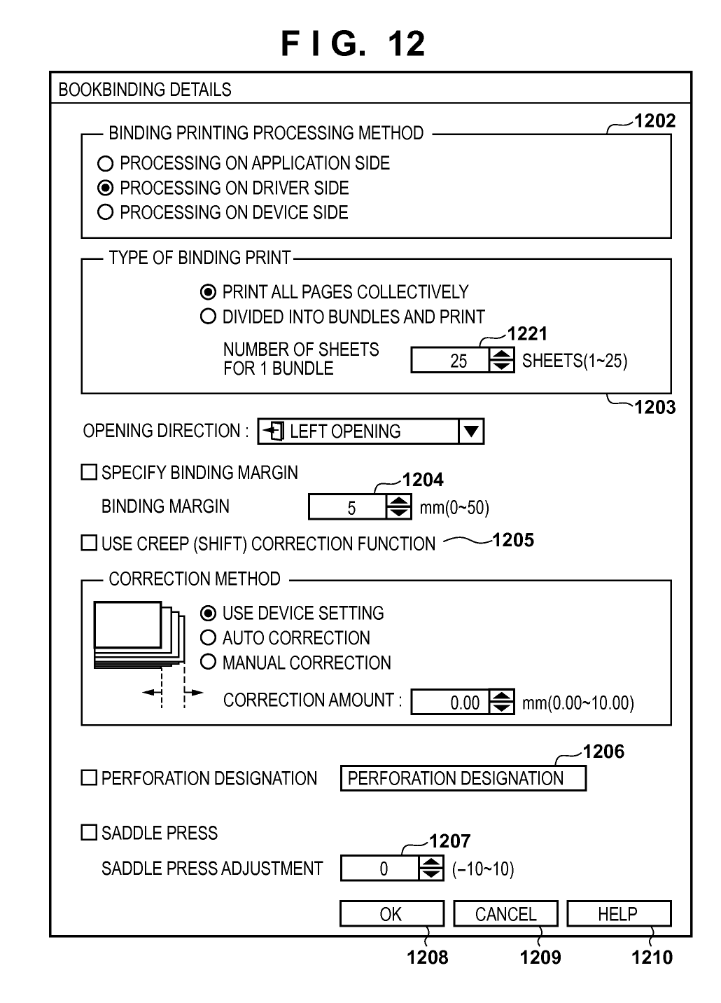

Also, FIG. 9 is a view for illustrating an example of a setting screen when saddle binding is selected. In FIG. 9, reference numeral 902 denotes a display example of a double-page spread when executing saddle binding. When the bookbinding details button 703 is pressed, a window (FIG. 12) is displayed in which only items designatable when saddle binding are selectable.

FIG. 12 is a view for illustrating an example of a binding details screen.

This screen is displayed when the bookbinding details button 703 is pressed in a state in which saddle binding has been designated on the screen of FIG. 9.

By a binding print processing method 1202, where to designate the bookbinding processing is selected. In the first embodiment, “processing on a driver side”, which is for when the printer driver of the PC 205 performs binding processing, is selected. When “processing on the application side” is selected, because the printer driver does not perform the binding processing, items that are only set in a binding setting by the printer driver are grayed out or not displayed. Note that when the binding processing is performed by the application, similarly to the first embodiment, it is necessary to determine whether or not the perforation processing is set effectively in the application. Alternatively, configuration may be taken such that the application only sets the perforation, and transmits the print job without confirming consistency with other setting values, and that the consistency of the settings is determined by the printer driver or on the image forming apparatus side, which has received the job from the application. Note that a case when processing is performed on the device side will be explained later.

Returning to FIG. 12 once again, a bookbinding print type 1203 is set in units of bookbinding prints (a number of pages for which folding in half is performed collectively). “print all pages collectively” means to collectively fold in half and bind all of the sheets that are output. “divide into bundles and print” means to fold in half and bind collectively bundles each being of a designated number of sheets. When “divide into bundles and print” is selected, one bundle is bound for the number of pieces designated in a number of sheets per bundle box 1221.

By a binding margin 1204, a margin (binding margin) on one side of a printed material is designated. The margin is referenced when the printed material is bound, and this is mainly used when binding on the printer driver side. A creep setting 1205 is for setting whether or not to use a function for adjusting the amount of margin so that a misalignment of a text position, or the like, will not occur between outer pages and inner pages due to the thickness of the sheets that are bound upon bookbinding printing. When misalignment of text positions between pages is eliminated, the margins up until the text position from the edge of the page of each page are aligned even when the page edge is trimmed by the trimmer. This is mainly used by bookbinding printing is performed at the image forming apparatus.

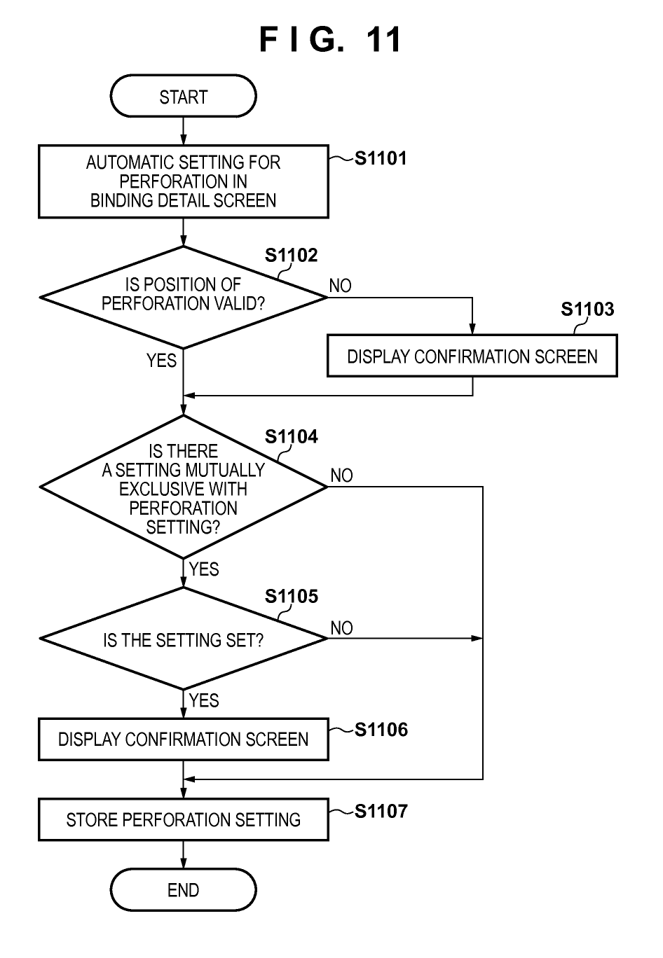

It is possible to designate a perforation when a perforation designation button 1206 is pressed. By the user pressing the perforation designation button 1206 in the screen of FIG. 12, the flowchart of FIG. 11 is started.

FIG. 11 is a flowchart for describing perforation setting processing when saddle binding is selected which is performed by a printer driver of the PC 205 according to the first embodiment. This processing is realized by the CPU 610 executing a program loaded into the RAM 613 of the PC 205.

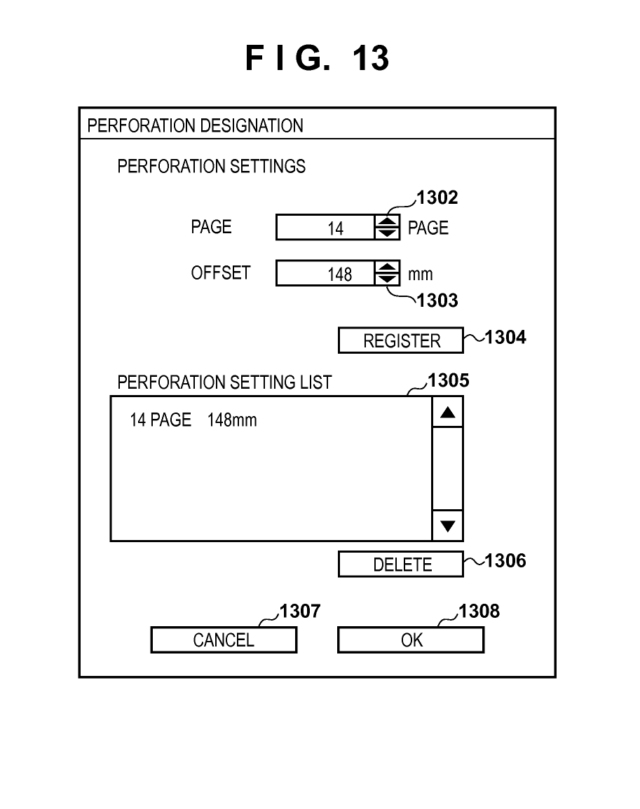

When the user presses the perforation designation button 1206 in the screen of FIG. 12, the processing proceeds to step S1101, and the CPU 610 displays a perforation setting screen, as shown in FIG. 13.

FIG. 13 is a view for illustrating an example of a perforation setting screen for setting a perforation according to the first embodiment.

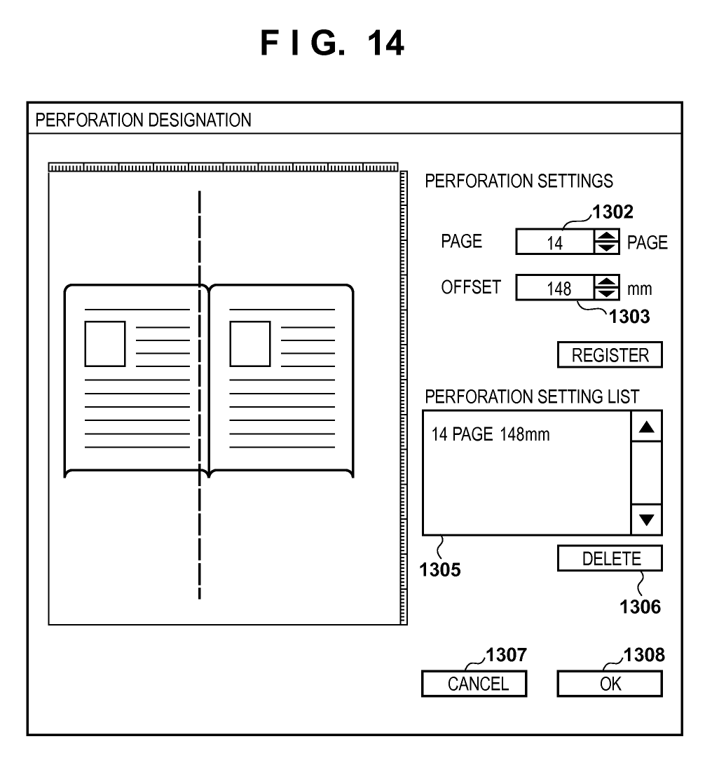

Note that here a preview screen may also be displayed beside a perforation setting screen as shown in FIG. 14. FIG. 14 is a view for showing an example of a screen in which a preview screen showing a position at which a perforation is set is displayed on the left side of the perforation setting screen of FIG. 13.

In the perforation settings of FIG. 13, a user designates a page 1302 to which to set the perforation, and designates a value of an offset (distance) 1303 from the left side of the page for the position of the perforation. Also, configuration may be taken such that a page number designated in the page 1302 cannot be designated if it exceeds the number of pages of the print data. Also, in the first embodiment, configuration is taken such that it is possible to designate a perforation for the front cover, but a separate perforation setting screen for the front cover may also be employed.

When the user inputs the page 1302 to which to set the perforation, and the offset value 1303, presses a register button 1304, and presses an OK button 1308, the processing of FIG. 11 transitions to step S1102, and the values that are set are reflected in a perforation setting list 1305. Here, if a mistaken designation is made, or if it is desired that a perforation setting that was already registered be changed, the selected item can be deleted by selecting the perforation setting desired to be deleted or changed and pressing a delete button 1306. Also, in a case where a change of the perforation setting is desired, first the item is deleted and then once again registration is performed. Also, a button may be prepared so that making a change is possible. When it is desired that the perforation settings be cancelled, the settings on the screen can be cancelled by pressing a cancel button 1307. Also, by pressing the OK button 1308, the perforation settings set on this screen are reflected.

When the OK button 1308 is pressed, the CPU 610 moves the processing to step S1102, and it is determined whether or not the perforation position that is set is valid.

In the first embodiment, because explanation will be given for whether or not the setting of the perforation position is valid in a case of performing stapling when saddle binding, it is assumed that the setting 904 for saddle stitching is set. When the saddle stitching setting 904 is not set, the instructed position of the perforation may be set as is without executing the following processing.

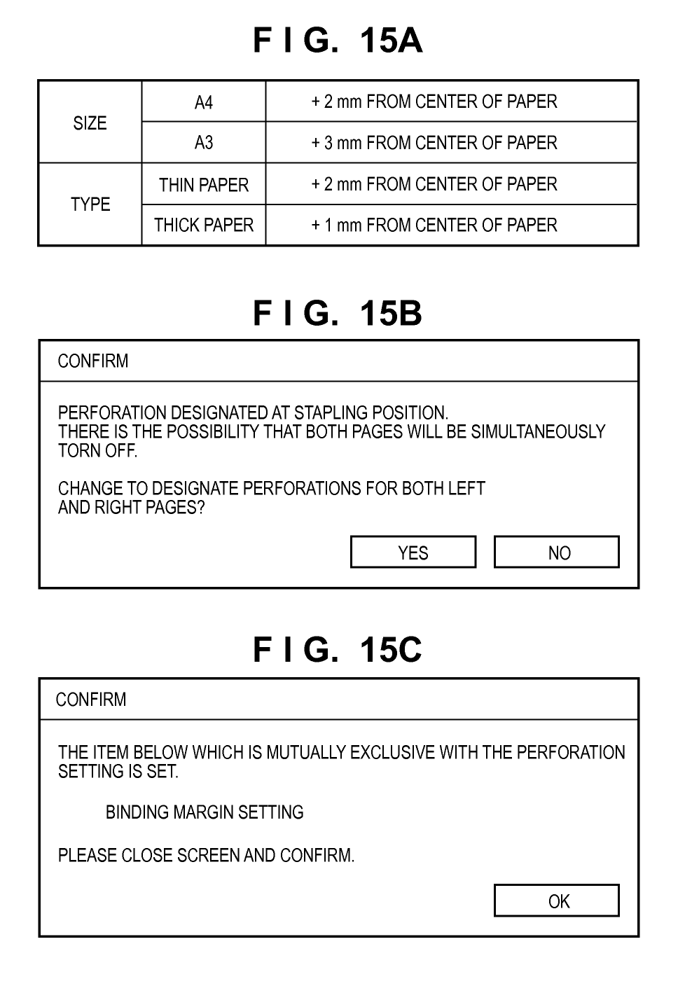

In step S1102, the CPU 610 determines whether the position of the perforation is valid (optimal) based on the size and type of the sheet used in the bookbinding. The position of the perforation corresponding to the size and the type (sheet type) of the sheet is determined in accordance with a table shown in FIG. 15A. As an example in the first embodiment, explanation will be given for the sizes being A4 and A3, and the types being thin paper and thick paper, but the optimal position may be detected by detecting other sheet sizes or types, or other the sheet properties (example: grammage).

FIG. 15A is a view for illustrating an example of how far from the center of the sheet the position needs to be for performing a perforation to be valid for each of A4 and A3 sizes, and thin paper and thick paper sheets.

If the sheet on which the perforation is performed is A4 thick paper, the perforation will be effective if made at a position of a total of 3 mm or greater from the center of the sheet (a staple position) because for A4 it is +2 mm and for thick paper it is +1 mm. Also, for the case of A3 thin paper the perforation is effective if positioned a total of 5 mm or greater from the center (the staple position) of the sheet because for A3 it is +3 mm and for thin paper it is +2 mm. Here, regarding from what distance from the center the perforation is effective, an amount of shift from the center is held on the printer driver side in accordance with the number and size of holes that the blade of the perforation unit that is used makes. Alternatively, a printer driver screen may allow the user to input these values by generating a user interface by which these values can be changed. Also, the necessary values may be obtained from the image forming apparatus. Furthermore, an optimal shift amount may be made to be a fixed value rather than holding one for each type of sheet. Also, configuration may be taken such that it is possible to switch between a fixed value and a means for detecting an optimal amount of shift for each sheet.

When, in step S1102, the CPU 610 determines that the position of the perforation that is designated is not valid, the processing proceeds to step S1103, and the CPU 610, as shown in FIG. 8A, for example, displays a confirmation screen based on the result of the determination. In other embodiments, a range that is currently not optimal may be displayed on the confirmation screen. Furthermore, because there is the possibility that both sides of the sheet will be cut off when the center of the sheet (a stapling position) is designated, a confirmation screen for confirming whether to make an effective perforation designation considering the previously described sheet size and type with respect to the left and right pages as in FIG. 15B is displayed. Furthermore, the user may be allowed to input whether to designate a perforation for both pages, and for input pages optimal perforation positions may be presented, and when the user authorizes these, it may be set so as to add the perforations at those positions. When the CPU 610 detects that the position of the perforation is valid in step S1102, or detects that the user confirmed on the confirmation screen in step S1103, the processing proceeds to step S1104.

In step S1104, the CPU 610 determines whether another setting that is mutually exclusive with the perforation setting exists. In the first embodiment, explanation will be given for mutual exclusion with the binding margin setting 1204 of FIG. 12. If the binding margin setting is set so to be more towards the center of the sheet than the perforation position, it does not necessarily mean that it is possible to set the perforation at an intended position. Therefore, when there is another setting that is related to the setting value of the perforation, the CPU 610 transitions to step S1105. When the CPU 610 determines in step S1104 that there is no such setting, the processing proceeds to step S1107, the perforation setting that is set is saved, and the bookbinding details screen of FIG. 12 is transitioned to.

Meanwhile, if, in step S1105, another setting that is mutually exclusive with the perforation setting, e.g. the binding margin setting, is set, the processing proceeds to step S1106, the confirmation screen shown in FIG. 15C is displayed, and the user is prompted to confirm the setting for the other item which is mutually exclusive. When, in step S1105, the CPU 610 detects that the user confirmed by pressing the OK button on the screen of FIG. 15C, the processing proceeds to step S1107, and the setting by the printer driver finishes. With this, a print job is issued to the image forming apparatus with the bookbinding settings that the user set. Note that for settings such as the binding margin setting that are mutually exclusive with perforation, when the value is not optimal when a perforation is set, a confirmation screen may be displayed to the user.

Once again, the explanation returns to the bookbinding details screen of FIG. 12. For a saddle press 1207, by adding a check to this item upon a saddle binding print, it is possible to press the sheet. When an OK button 1208 is pressed, the settings made on the screen are stored, and when saddle binding is selected by the print method 702 of FIG. 9, the screen of FIG. 9 is returned to. When a cancel button 1209 is pressed, the screen of FIG. 9 is returned to without saving the settings set on this screen. When a help button 1210 is pressed, a help for the items is displayed.

Next, explanation will be given for an embodiment for when a user selects case binding as the print method 702 on the screen of FIG. 7. FIG. 10 shows an example of a screen used when the user selects a case binding for the print method 702.

In FIG. 10, reference numeral 1002 denotes an image for performing case binding. Here, when the bookbinding details button 703 is pressed, a window in which only items designatable upon case binding are selectable is opened. Here, for example, the bookbinding details screen as shown in the previously described FIG. 12 is displayed. Because the items of FIG. 12 have been explained previously, the explanation is omitted. When the bookbinding details button 703 is pressed upon a case binding, those items that are not useable in the bookbinding details screen are grayed out. For example, because the bookbinding print type 1203, the binding margin setting 1204, the creep setting 1205, and the saddle press setting 1207 are items that cannot be designated upon case binding, these not displayed.

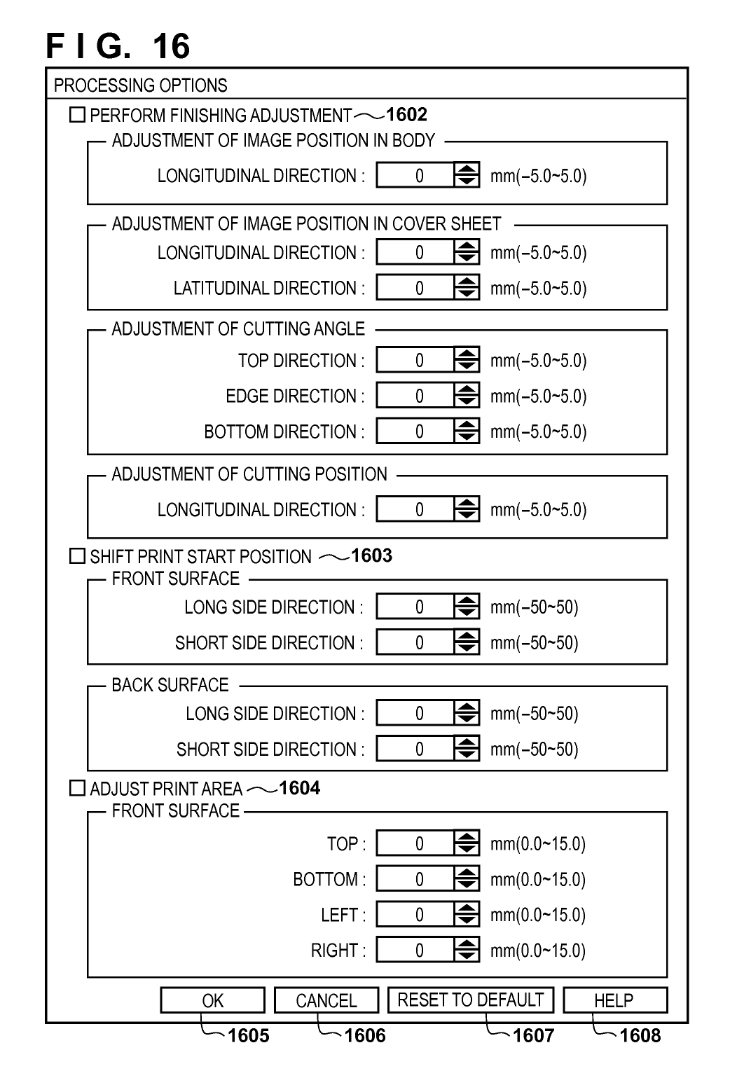

In FIG. 10, reference numeral 1004 is a setting for the front cover upon case binding. When the button 1005 for performing the case binding finishing setting is pressed, a print finishing setting screen such as the one shown in FIG. 16 is displayed.

FIG. 16 is a view for illustrating an example of a case binding finishing setting screen according to the first embodiment.

By a finishing adjustment setting item 1602 it is possible to adjust a finishing size when performing case binding, gluing the body to the front cover, and an image position of the body/front cover, and to adjust a cutting angle and position. A shift print start position setting 1603 designates a position at which to start a print. A printing area adjustment item 1604 sets a print margin.

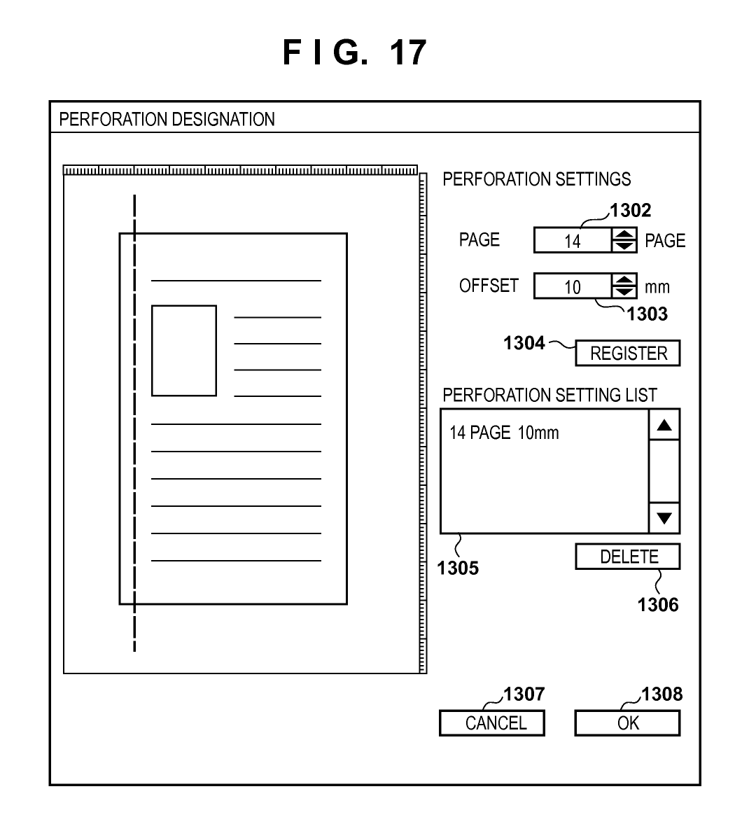

Next, the explanation returns to FIG. 12. When a perforation designation button 1206 is pressed in FIG. 12, the CPU 610 transitions to step S1101 of FIG. 11. The CPU 610 displays a screen for performing perforation settings as shown in FIG. 13. Note that configuration may also be taken such that here a preview screen may also be displayed on the left side of the perforation setting screen as shown in FIG. 17.

FIG. 17 is a view for showing an example of a screen in which a preview screen showing a position at which a perforation is set is displayed on the left side of the perforation setting screen. Because the perforation setting screen of FIG. 17 is explained with reference to FIG. 13, explanation will be omitted.

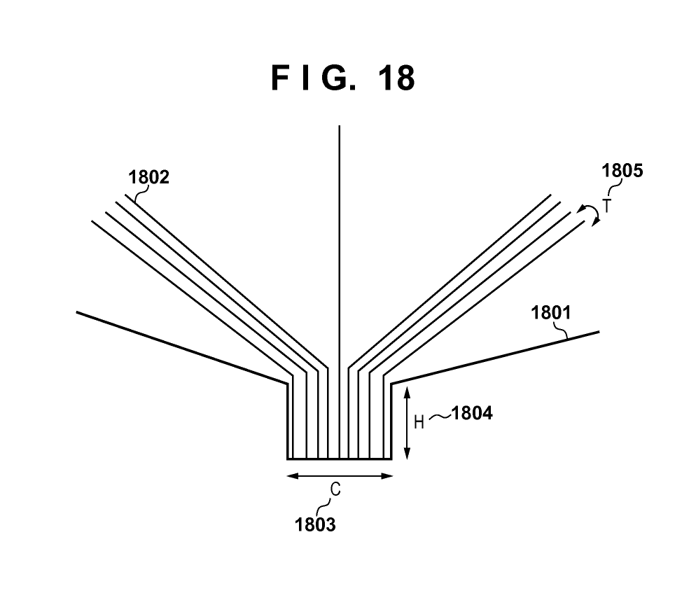

When the OK button 1308 is pressed in the screen of FIG. 13, the processing proceeds to step S1102 of FIG. 11, and the CPU 610 determines whether or not the perforation position that is set is optimal (valid). Explanation will be given for determination of whether or not the perforation position is valid when case binding with reference to FIG. 18.

FIG. 18 is a view seen from above a resulting document for which a case binding is performed in the first embodiment.

Reference numeral 1801 denotes a front cover of the resulting document for which the case binding is performed, and reference numeral 1802 denotes the contents of the resulting document for which the case binding is performed. In FIG. 18, contents 1802 is comprised of nine printed materials, and C 1803 denotes a variable that indicates the number of sheets in the contents of the case binding; here it is 9. Also, H 1804 represents a height of a glued portion in the case binding, and may be a height up to a fold in the front cover. T 1805 denotes a thickness of a sheet, and also a grammage may be used. Here, using C, H, T, and a current page number n, an optimal position for the perforation upon the case binding can be represented by H+n×T from the first sheet to the (C/2)-th sheet, and represented by H+(C−n)×T from the (C/2)-th sheet up to the C-th sheet.

Note that in the first embodiment, explanation is given for a case in which the contents of the case binding are all the same kind of sheets, but when various kinds of sheets are used for the contents, a calculation equation that adds this into the equation may be used. Also, the same value may be used for all pages. Furthermore, configuration may also be taken such that the method of using the same value for all the pages, and the method of detecting the optimal location for each page can be switched.

When, in step S1102, the CPU 610 determines that the designated perforation position is not valid, the processing proceeds to step S1103, and, for example, the confirmation screen as shown in FIG. 15B is displayed, and the user is notified that a perforation position that is not optimal is designated. In other embodiments, a confirmation screen that changes the position to an optimal position may be displayed. Alternatively, a confirmation screen for instructing page movement when the position of the perforation is prioritized may be displayed.

When, in step S1103, the CPU 610 detects that the user confirmed by pressing the “YES” button or the “NO” button on the confirmation screen, the processing proceeds to step S1104. When the CPU 610, in step S1102, determines that the perforation position that is set is optimal, the processing proceeds to step S1104. In step S1104, the CPU 610 determines whether another setting that is mutually exclusive with the perforation setting exists. In the first embodiment, the finishing adjustment 1602, the shift print start position 1603, and the printing area adjustment 1604 of FIG. 16 correspond to this. If these settings are set so to be more towards the center of the sheet than the optimal perforation position, it does not necessarily mean that it is possible to set the perforation at an intended position. Therefore, when there is such a setting that is related to the setting of the perforation, the CPU 610 transitions to step S1105. Because explanation for the processing from step S1105 is the same as the previously described saddle binding case, the explanation is omitted.

In the image forming apparatus according to the first embodiment, it is possible to print having designated the binding of the printed material and designated a perforation based on an original document that is scanned by the scanner unit 202. The method of the bookbinding designation and the method of the perforation designation can be set substantially similarly when printing from the above described printer driver. Because it is also possible to similarly realize a method for confirming whether or not the value for the perforation that is set is at an optimal position when performing various bookbinding settings, such explanation is omitted.

Next, explanation will be given for processing a job in which a perforation is designated in the image forming apparatus (MFP) 200 according to the first embodiment.

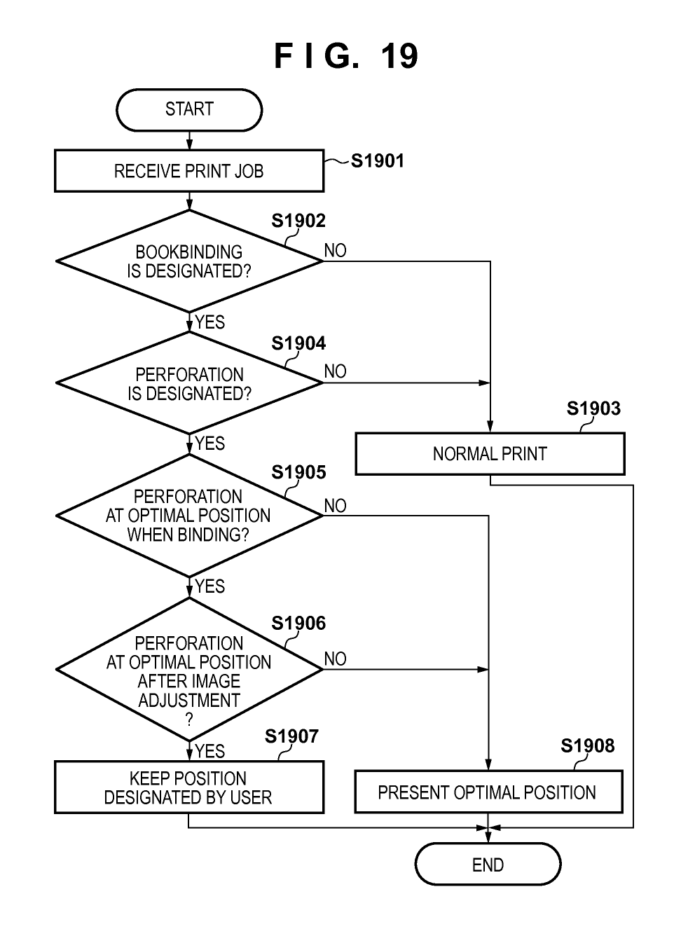

FIG. 19 shows a flowchart in which the image forming apparatus 200 according to the first embodiment processes a job in which a perforation is designated. The processing illustrated by the flowchart is realized by the CPU 402 executing a program loaded into a memory. In the first embodiment, explanation is given for a case in which by an application capable of making a bookbinding designation, and a perforation designation, a job is generated in a state in which a bookbinding setting and an optimal position for a perforation designation cannot be considered, and the job is transmitted to the image forming apparatus 200.

Firstly, in step S1901, when the CPU 402 receives the print job, the processing proceeds to step S1902. In step S1902, the CPU 402 determines whether or not the job received in step S1901 makes a bookbinding designation, and in a case where it is determined that there is no bookbinding designation, the processing proceeds to step S1903, a normal print is performed, and the processing completes.

On the other hand, in a case where the CPU 402, in step S1902, determines that there is a bookbinding designation, the processing proceeds to step S1904, and the CPU 402 determines whether or not a perforation is set. Here, in a case where the CPU 402 determines that a perforation is not designated, the processing proceeds to step S1903, a normal print is performed, and the processing completes.

In a case where the CPU 402, in step S1904, determines that a perforation is designated, the processing proceeds to step S1905, and it is determined whether or not the designation of the perforation is for an optimal (valid) position when binding. The determination method was already explained previously, and so the explanation is omitted. In a case where it is determined that the position is optimal when binding in step S1905, the processing proceeds to step S1906, and image forming adjustment is performed, and once again it is determined whether the position is optimal. For example, when the creep correction function 1205 is designated upon a saddle binding, a correction of a print position is performed in the image forming apparatus. After this correction is performed, it is determined whether or not the position of the perforation which is previously designated at an optimal position has become non-optimal. In a case where it is determined that the position is optimal after the adjustment, the processing proceeds to step S1907, printing is performed at the position that the user designated, and the processing completes.

On the other hand, when the CPU 402, in step S1905 or in step S1906, determines the position to not be optimal, the processing proceeds to step S1908, and the CPU 402 presents to the user an optimal perforation position. Alternatively, the perforation position may be automatically changed to a valid (optimal) position without presenting it to the user.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-046758, filed Mar. 10, 2014, which is hereby incorporated by reference wherein in its entirety.

What is claimed is:

1. A sheet processing apparatus operable to add a perforation to a sheet on which bookbinding processing is performed comprises
a first determination unit configured to determine whether or not a perforation is set for a sheet on which bookbinding processing is performed;
a second determination unit configured to, when it is determined by the first determination unit that the perforation is set, determine whether or not a position of the set perforation is valid; and
a presentation unit configured to present a result determined by the second determination unit to a user.

2. The sheet processing apparatus according to claim 1, further comprising a change unit configured to, when the second determination unit determines that the set perforation is not valid, change the position of the set perforation.

3. The sheet processing apparatus according to claim 1,
the second determination unit
comprises a storage unit configured to store a position of a perforation on a sheet corresponding to a sheet size and/or a sheet type, and determines whether or not the position of the set perforation is valid based on the position of the perforation set for the sheet, and the sheet size and/or the sheet type, and the position of the perforation stored in the storage unit.

4. An information processing apparatus operable to issue a job including bookbinding processing using a sheet, the apparatus comprising:
an instruction unit configured to make an instruction for a setting of a perforation for a sheet on which bookbinding processing is performed;
a designation unit configured to, when the setting of the perforation is instructed by the instruction unit, designate a page for which the perforation is set and a position of the perforation;
a first determination unit configured to determine whether or not the position of the perforation designated by the designation unit is valid; and
a presentation unit configured to present to a user a result of the determination by the first determination unit.

5. The information processing apparatus according to claim 4, wherein the position of the perforation is indicated by a distance from a binding position of the bookbinding processing.

6. The information processing apparatus according to claim 4, further comprising a display unit configured to display a preview screen for indicating the position of the perforation.

7. The information processing apparatus according to claim 4,
further comprising a storage unit configured to store a position of a perforation of a sheet corresponding to a sheet size and/or a sheet type, wherein
the determination unit determines whether or not the position of the perforation designated by the designation unit is valid based on size and/or type of the sheet for which the setting of the perforation is instructed by the instruction unit, and the position of the perforation stored by the storage unit.

8. The information processing apparatus according to claim 4, further comprising:
a second determination unit configured to determine whether or not a setting that is mutually exclusive to the setting of the perforation is made for the sheet, and
a confirmation unit configured to confirm with a user when it is determined by the second determination unit that the setting that is mutually exclusive to the setting of the perforation is made.

9. The information processing apparatus according to claim 8, wherein the setting that is mutually exclusive to the setting of the perforation includes at least one of a binding margin setting for the sheet, an adjustment of an image position at which to print on the sheet, an adjustment of a print start position, and an adjustment of a printing area.

10. The information processing apparatus according to claim 4, wherein the bookbinding processing includes saddle stitch bookbinding or case binding.

11. A method of controlling a sheet processing apparatus operable to add a perforation to a sheet on which bookbinding processing is performed, the method comprising:
a first determination step of a first determination unit determining whether or not a perforation is set for a sheet on which bookbinding processing is performed;
a second determination step of a second determination unit, when it is determined by the first determination step that the perforation is set, determining whether or not a position of the set perforation is valid; and
a presenting step of a presentation unit presenting to a user a result of the determination by the second determination step.

12. A method of controlling an information processing apparatus operable to issue a job including bookbinding processing using a sheet, the apparatus comprising:
an instruction step of an instruction unit making an instruction for a setting of a perforation for a sheet on which bookbinding processing is performed;
a designation step of a designation unit, when the setting of the perforation is instructed by the instruction step, designating a page for which the perforation is set and a position of the perforation;
a first determination step of a first determination unit determining whether or not the position of the perforation designated by the designation step is valid; and
a presenting step of a presentation unit presenting to a user a result of the determination by the first determination step.

13. A computer readable storage medium which stores a program for causing a computer to function as the sheet processing apparatus according to claim 1.

14. A computer readable storage medium which stores a program for causing a computer to function as the information processing apparatus according to claim 4.
